(19) United States
(12) Patent Application Publication
(10) Pub. No.: US 2017/0197362 A1
(43) Pub. Date: Jul. 13, 2017

(54) SACRIFICIAL CORE FOR CONGLOMERATED POWDER REMOVAL

(71) Applicant: United Technologies Corporation, Hartford, CT (US)

(72) Inventors: Evan Butcher, Manchester, CT (US); Thomas J. Ocken, DesMoines, IA (US); Kiley James Versluys, Hartford, CT (US); Wendell V. Twelves, JR., Glastonbury, CT (US)

(21) Appl. No.: 15/074,644

(22) Filed: Mar. 18, 2016

Related U.S. Application Data
(63) Continuation-in-part of application No. 14/994,351, filed on Jan. 13, 2016.

(51) Int. Cl. B29C 67/00

(52) U.S. Cl. CPC B29C 67/0066; B33Y 10/00

(57) ABSTRACT

A method of making a part including a solid portion with an internal passage includes building the part using an additive manufacturing process that builds the part on a layer-by-layer basis. The solid portion of the part is formed. A solid core is formed within at least a portion of the internal passage. Forming the solid core includes forming an attachment feature and forming a shearing feature. Material that is not fused, either semi-sintered or un-sintered, is positioned between the solid portion and the solid core. A force selected from the group consisting of a tensile, compressive, vibratory, and torsional force is applied to the solid core at the attachment feature. The material is then shorn with the shearing feature.

### CROSS-REFERENCE TO RELATED APPLICATIONS

This application claims priority as a continuation-in-part application of earlier filed application Ser. No. 14/998,351 entitled “Method For Removing Partially Sintered Powder From Internal Passages In Electron Beam Additive Manufactured Parts” and filed Jan. 13, 2016, which is hereby incorporated by reference in its entirety.

### BACKGROUND

The present invention relates generally to additive manufacturing, and more particularly to additively manufacturing a part with an internal passage.

Additive manufacturing is an established but growing technology that includes layerwise construction of articles from thin layers of feed material. Additive manufacturing can involve applying liquid or particulate material to a workstage, then sintering, curing, melting, etc. to create a layer. The process is repeated up to several thousand times or more to construct the desired finished component or article.

In some metal additive manufacturing processes, such as electron beam melting (“EBM”), conglomerated powder can build up inside internal passages of the additive manufactured parts. This extra conglomerated powder in the part therefore must be removed in order for the internal passages of the additively manufactured part to be finished to desired specifications.

In an additive manufacturing process such as electron beam melting (“EBM”), or electron beam powder bed additive manufacturing, energy input into a metal powder bed during the build process will melt a cross section of a solid part. However, where the part includes one or more internal passages, the electron beam energy will also tend to cause metal powder inside of the internal passages to become stuck together during the build process. As part of the EBM or electron beam powder bed additive manufacturing process, the entire layer of powdered material is semi-sintered (synonymous with partially sintered) to reduce the effects of powdered material scattering when the negatively charged electron beam is applied to the powder bed. Once the part is built, the semi-sintered layers of powdered material remain inside internal passages of the part. In order to finish the part, the extra semi-sintered metal powder inside the internal passages therefore must be removed by some mechanical, abrasive, chemical, or vibratory method to retrieve only the solid part. An example strategy to remove excess conglomerated, or semi-sintered, powder from the part can include accelerating like powder from a grit blast nozzle to liberate (knock loose) the semi-sintered particles from the part. Accelerated powder can be effective but only to a certain depth limit, e.g., aspect ratio, for removing semi-sintered powder from the internal passages, and only within line-of-sight access from a point exterior to the part.

When building an additively manufactured part with an internal passage, conglomerated powder becomes entrapped in the internal passage. There are a few methods known to directly and quickly remove the conglomerated powder from internal passages. One example of a standard practice consists of repeatedly using the accelerated powder blast, combined with mechanically scraping conglomerated power out of the passage.

### SUMMARY

A method of making a part including a solid portion with an internal passage includes building the part using an additive manufacturing process that builds the part on a layer-by-layer basis. The solid portion of the part is formed. A solid core is formed within at least a portion of the internal passage. Forming the solid core includes forming an attachment feature and forming a shearing feature. Material that is not fused, either semi-sintered or un-sintered, is positioned between the solid portion and the solid core. A force selected from the group consisting of a tensile, compressive, vibratory, and torsional force is applied to the solid core at the attachment feature. The material is then shorn with the shearing feature.

According to another embodiment, a method of making a part including a solid portion with an internal passage includes creating a computer file defining the part in layers. The part is built using an additive manufacturing process that builds the part on a layer-by-layer basis. A solid core is formed within at least a portion of the internal passage. The solid core includes a plurality of solid core segments. A shearing feature is formed on each of the plurality of solid core segments. An attachment feature is formed on the solid core. Material that is not fused, either semi-sintered or un-sintered, is positioned between the solid portion and the solid core. Tooling is engaged with the attachment feature. A force selected from the group consisting of a tensile, compressive, vibratory, and torsional force is applied to the solid core. The solid core is detached from the part. The material is then shorn with the shearing feature.

The present summary is provided only by way of example, and not limitation. Other aspects of the present disclosure will be appreciated in view of the entirety of the present disclosure, including the entire text, claims and accompanying figures.

### BRIEF DESCRIPTION OF THE DRAWINGS

FIG. 1 is a cross-sectional view of an embodiment of an additively manufactured part with a drill bit shaped core.

FIG. 2A is a side view of an embodiment of the drill bit shaped core, shown in isolation.

FIG. 2B is a side view of another embodiment of the drill bit shaped core, shown in isolation.

FIG. 2C is a side view of yet another embodiment of the drill bit shaped core, shown in isolation.

FIG. 2D is a side view of yet another embodiment of the drill bit shaped core, shown in isolation.

FIG. 2E is a side view of yet another embodiment of the drill bit shaped core, shown in isolation.

FIG. 3 is a sectional view of an embodiment of a multi-segment core of an additively manufactured part.

FIG. 4 is a cross-sectional view of the embodiment of the multi-segment core taken along line 4-4 of FIG. 3.

FIG. 5 is a cross-sectional view of the embodiment of the multi-segment core taken along taken along 5-5 of FIG. 3.

FIG. 6 is a cross-sectional view of an embodiment of an additively manufactured part with a core located off-center relative to an internal passage of the additively manufactured part.

FIG. 7 is a cross-sectional view of another embodiment of a multi-segment core of an additively manufactured part.

FIG. 8 is a perspective view of yet another embodiment of a multi-segment core shown in isolation.

FIG. 9 is a flowchart of a method of additively manufacturing a part with a core.

While the above-identified figures set forth embodiments of the present invention, other embodiments are also contemplated, as noted in the discussion. In all cases, this disclosure presents the invention by way of representation and not limitation. It should be understood that numerous other modifications and embodiments can be devised by those skilled in the art, which fall within the scope and spirit of the principles of the invention. The figures may not be drawn to scale, and applications and embodiments of the present invention may include features, steps and/or components not specifically shown in the drawings.

### DETAILED DESCRIPTION

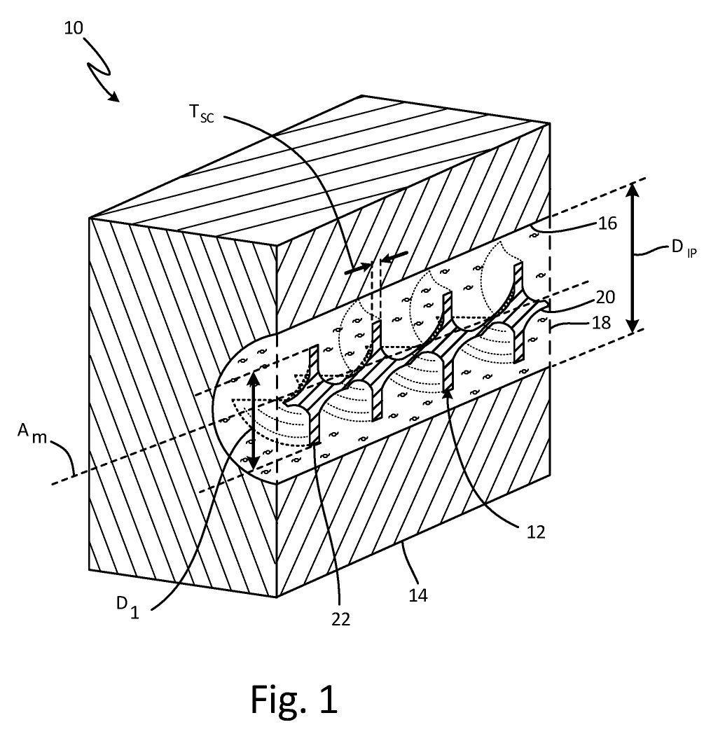

FIG. 1 is a cross-sectional view of an embodiment of additively manufactured part 10 which includes solid core 12, solid portion 14, internal passage 16, and material 18. Material 18 is semi-sintered or un-sintered. Solid core 12 includes attachment feature 20 and shearing portion 22.

Additively manufactured part 10 is built by either EBM or electron beam powder bed additive manufacturing process. As additively manufactured part 10 is built, material 18 is semi-sintered or left un-sintered (i.e., in powder form, without significant inter-particle attachment) within internal passage 16 between solid core 12 and solid portion 14. Throughout the build process, solid core 12 is fused to the same or similar degree as solid portion 14. Once the additive manufacturing process is complete, solid core 12 is formed as a fully-fused solid core and is attached to material 18. Material 18 is positioned within internal passage 16 and is attached to solid portion 14. Additively manufactured part 10 can be built from powdered material such as a nickel superalloy, aluminum alloy, titanium alloy, steel alloy, cobalt alloy, or other suitable metal. While EBM and electron beam powder bed additive manufacturing processes are primarily described, other additive manufacturing techniques can be employed, such as, for example, direct metal laser sintering (DMLS), laser powder bed fusion, electron beam powder bed fusion, laser powder deposition, electron beam wire, and selective laser sintering, as well as other powder bed methods in general.

For example, powder bed methods use a bed of metallic powder that rests on top of a platform to form the layers. A heat source, such as a laser or electron beam, sinters or fuses the metallic powder over the platform. The fused layer becomes the first layer. After the first layer is formed, the platform, along with the first layer, lowers and un-fused powder fills in the void over the first layer. That powder is then sintered or fused to form a second layer. Powder bed methods work well with metals as well as plastics, polymers, composites and ceramics.

After the first layer is produced, additional layers can be produced using the same method that formed the previous layer. The apparatus forms each layer with reference to a computer file, or computer aided design (“CAD”) data, defining the part in layers. The CAD data can relate to a particular cross-section of additively manufactured part 10A. For example, the CAD data can include geometric data relating to cylindrical core 12A, solid portion 14, internal passage 16, and material 18A. With the layers built upon one another and joined to one another cross-section by cross-section, additively manufactured part 10A can be produced to include to include particular geometries and internal features. A single-piece cylindrical core 12A can be produced that requires no further assembly and can be directly built inside of internal passage 16.

The example powder bed additive manufacturing process discussed here is described in commonly assigned U.S. patent application Ser. No. 14/960,997 to Butcher et al. entitled “Adjusting Process Parameters To Reduce Conglomerated Powder” and filed Dec. 7, 2015.

Solid core 12 is a solid core in the sense that solid core 12 is fused to the same degree as additively manufactured part 10. In the illustrated embodiment, solid core 12 has a long, narrow strip shape which can extend along internal passage 16. In further embodiments (not shown), solid core 12 can also include a hollow center, as well as simple and/or complex geometries throughout an interior of solid core 12 such as truss structures or lattice structures. Thickness T_{SC} of solid core 12 can be less than 1/10 of diameter D_{IP} of internal passage 16. A width of solid core 12, shown as helical diameter D₁, is greater than thickness T_{SC} of solid core 12 but less than diameter D_{IP} of internal passage 16. In further embodiments, the shape of solid core 12 can vary to include other shapes, sizes, widths, and thicknesses as desired for particular embodiments.

Solid core 12 includes shearing portion 22 which includes a helix with a radial shape of a circle that is twisted about major axis Aₘ in this embodiment. In various other embodiments, shearing portion 22 can be a helix with a radial shape (i.e., a silhouette perimeter shape projected along major axis Aₘ) of an oval, square, or triangle, as well as include varying degrees of twist for example. A pitch of shearing feature 22 can be constant or can vary along Aₘ and can have any suitable value.

Attachment feature 20 is formed on solid core 12 during an additive manufacturing build process. Attachment feature 20 is configured to receive tooling for attaching with solid core 12. Attachment feature 20 can include one or more features such as a hole, bore, tongue, groove, receptacle, link, insert, chuck, socket, clamp, or other type of engagement feature configured to engage with tooling such as a hex drive, square drive, or other suitable attachment form factors. Once tooling is engaged to attachment feature 20, at least one of a tensile, compressive, vibratory, or torsional force is applied to solid core 12 at attachment feature 20 to detach solid core 12 from material 18. The at least one of a tensile, compressive, vibratory, or torsional force can be applied, for instance, by standard compressive hammer drill, tensile hammer drill, impact hammer, impact wrench, breaker bar, drill, hand tool, and/or through application of vibration. These applied forces can be monotonic or cyclical. Once solid core 12 is detached from material 18, shearing feature 22 shears material 18 from internal passage 16. Shearing feature 22 actively removes material 18 from internal passage 16 by coming into contact with material 18 and shearing at least a portion of material 18. Shearing feature 22 imparts a localized shearing action on material 18, thereby separating weak inter-particle bonds in material 18, which causes material 18 to be shorn away from internal passage 16.

Solid core 12 is then extracted from additively manufactured part 10. Any remaining material 18 is then removed from internal passage 16 through powder recovery system (“PRS”) or abrasive flow techniques. PRS techniques include blasting powder at the part to break apart material 18. Abrasive flow techniques include flowing a liquid containing abrasive particles through internal passage 16 to remove material 18.

Forming additively manufactured part 10 with solid core 12 allows for manufacturability of internal passage 16 of additively manufactured part 10 by allowing the removal of material 18 from deep or high aspect ratio passages. Forming additively manufactured part 10 with solid core 12 also allows for better thermal conductivity to the adjacent passage walls, which in turn enables better manufacturability, reduced surface roughness on passage walls, and improved dimensional results in the as-produced state. A smaller amount of support structures will also be required on the interior of internal passage 16, due to solid core 12 being solid which allows for greater thermal conduction than a powder bed alone, which can be a prevalent issue particularly in laser powder bed fusion processes.

The benefits of using solid core 12 can further include reducing the amount of material 18 to be removed from internal passage 16 due to the void left from solid core 12 after solid core 12 is removed from additively manufactured part 10. The void left from solid core 12 allows for less material 18 left in internal passage 16 after the build process (as compared to if a solid core was not used) resulting in less material 18 required to be removed by PRS and/or abrasive flow techniques. Use of cylindrical core 12A also allows material 18A to be removed from internal passage due to the increased access to material 18A after cylindrical core 12A is removed. If cylindrical core 12A were not used, for example, material 18A could not all be removed from all portions of internal passage 16 and additively manufactured part 10A would not functioned as desired.

Additionally, shearing feature 22 enables solid core 12 to actively remove material 18 from internal passage 16 as solid core 12 is extracted from additively manufactured part 10. Actively removing material 18 during the extraction of solid core 12 reduces an amount of powder removal techniques (e.g., PRS or abrasive flow) that are required to adequately remove the remaining portions of material 18 from internal passage 16 in order to allow additively manufactured part 10 to operate as desired.

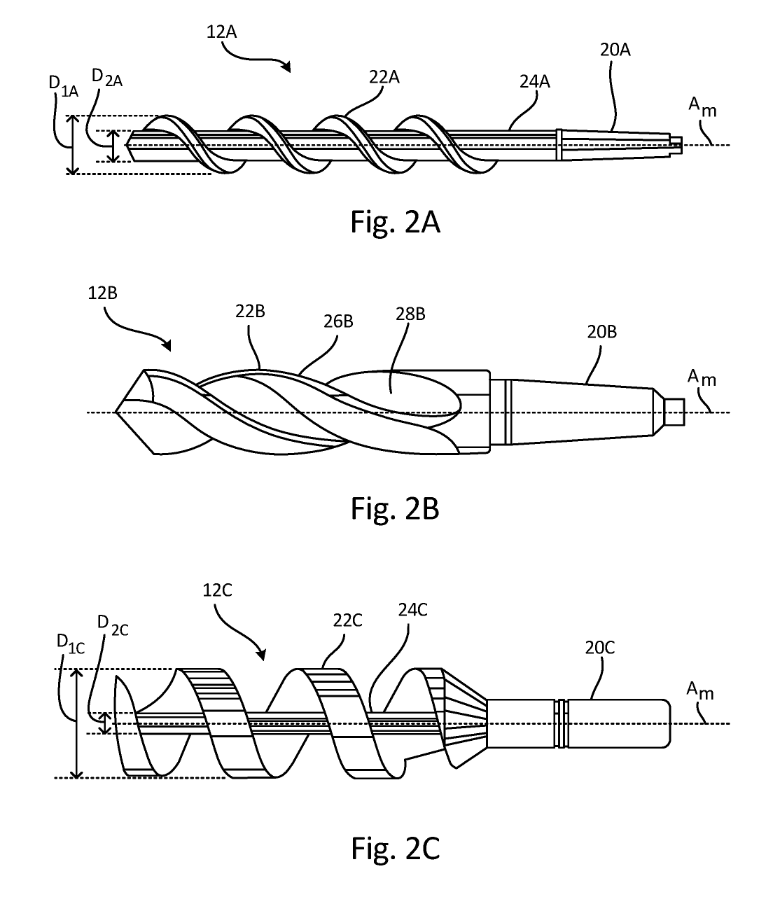

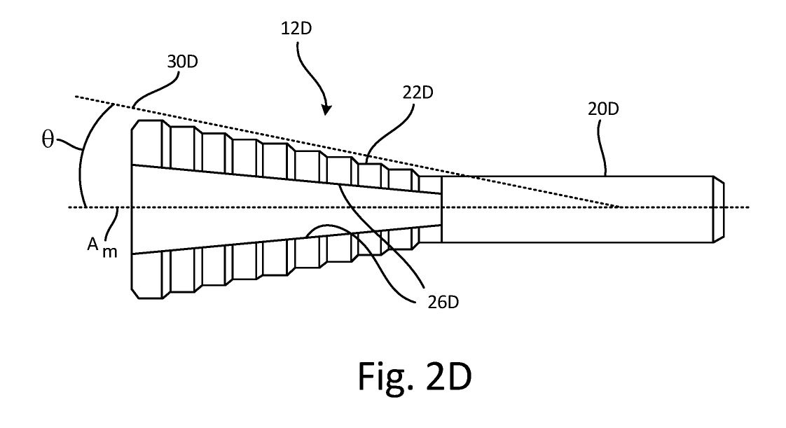

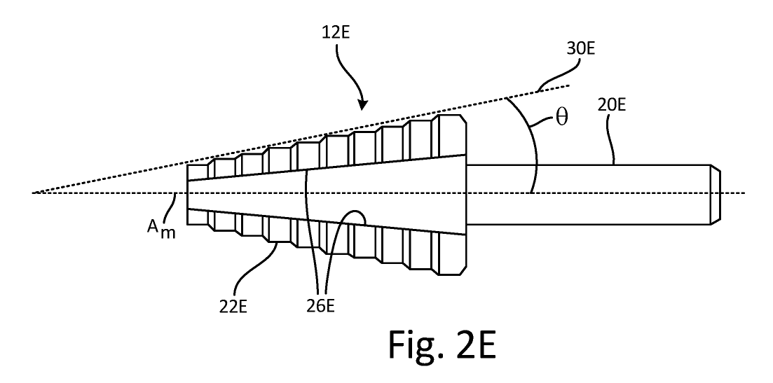

FIG. 2A is a side view of solid core 12A, shown in isolation. Solid core 12A includes attachment feature 20A and shearing feature 22A. Shearing feature 22A includes a helical shape which wraps around center element 24A. Each of attachment feature 20A, shearing feature 22A, and center element 24A are all integrally formed as a single article during the additive manufacturing build process.

After solid core 12A is detached from material 18, solid core 12A is rotated about major axis Aₘ of solid core 12A, wherein major axis Aₘ extends through a center of solid core 12A. As solid core 12A is rotated, shearing feature 22A shears material 18 from internal passage 16. Shearing feature 22A actively removes material 18 from internal passage 16 by coming into contact with material 18 and shearing material 18. Shearing feature 22A imparts a localized shearing action on material 18, thereby separating weak inter-particle bonds in material 18, which causes material 18 to be shorn away from internal passage 16.

In this embodiment, shearing feature 22A includes helical diameter D_{1A} that is approximately twice as large as diameter D_{2A} of center element 24A. In other embodiments, a value of helical diameter D_{1A} can fall between the range of D_{2A}<D_{1A}≦a diameter of internal passage 16.

In further embodiments, the shape of shearing feature 22A can vary to include other shapes, sizes, widths, and thicknesses as well as varying degrees of twist as desired for particular embodiments. In various embodiments, shearing portion 22A can be a helix with a radial shape of a circle (shown in FIG. 2A), oval, square, or triangle, as well as other non-symmetrical shapes for example.

FIG. 2B is a side view of solid core 12B, shown in isolation. Solid core 12B includes attachment feature 20B and shearing feature 22B. Shearing feature 22B includes ridges 26B which wrap around solid core 12B. Each of attachment feature 20B, shearing feature 22B, and ridges 26B are all integrally formed as a single article during the additive manufacturing build process.

In this embodiment, shearing feature 22B includes two ridges 26B. In other embodiments, quantities of ridges 26B can vary to be more or less than two. In further embodiments, the shape of shearing feature 22B can vary to include other shapes, sizes, widths, and thicknesses as well as varying degrees of twist as desired for particular embodiments. In various embodiments, shearing portion 22B can include a helix with a radial shape of a circle, oval, square, or triangle, as well as other non-symmetrical shapes for example.

FIG. 2C is a side view of solid core 12C, shown in isolation. Solid core 12C includes attachment feature 20C and shearing feature 22C. Shearing feature 22C has a helical shape that wraps around center element 24C. Each of attachment feature 20C, shearing feature 22C, and center element 24C are all integrally formed as a single article during the additive manufacturing build process.

In this embodiment, shearing feature 22C includes helical diameter D_{1C} that is approximately five times as large as diameter D_{2C} of center element 24C. In other embodiments, a value of helical diameter D_{1C} can fall between the range of D_{2C}<D_{1C}≦a diameter of internal passage 16.

In further embodiments, the shape of shearing feature 22C can vary to include other shapes, sizes, widths, and thicknesses as well as varying degrees of twist as desired for particular embodiments. In various embodiments, shearing portion 22C can be a helix with a radial shape of a circle (shown in FIG. 2D), oval, square, or triangle, as well as other non-symmetrical shapes for example.

FIG. 2D is a side view of solid core 12D, shown in isolation. Solid core 12D includes attachment feature 20D and shearing feature 22D. Shearing feature 22D includes ridge 26D. Shearing feature 22D includes a tapered shape that widens away from attachment feature 20D. Each of attachment feature 20D and shearing feature 22D are all integrally formed as a single article during the additive manufacturing build process.

Once solid core 12D is detached from material 18, shearing feature 22D shears material 18 from internal passage 16. Shearing feature 22D actively removes material 18 from internal passage 16 by coming into contact with material 18 and shearing at least a portion of material 18. Shearing feature 22D imparts a localized shearing action on material 18, thereby separating weak inter-particle bonds in material 18, which causes material 18 to be shorn away from internal passage 16. Specifically, as solid core 12D is rotated, ridge 26D cuts into material 18 and shears material 18. Upon one complete revolution of solid core 12D, solid core 12D can be moved in an axial direction and positioned to cut another full revolution of material 18. These steps can be repeated to produce a step-wise cutting process until solid core 12D is completely removed from internal passage 16.

The functionality of shearing feature 22D is similar to that of broaching. Broaching, which includes a toothed tool called a broach, includes removing material from a workpiece with the broach. Rotary broaching, similar to the described use of solid core 12D above, includes rotating and pressing the rotary broach into the workpiece to cut an axis symmetric shape. With rotary broaching, a cut is completed after a single rotation of the rotary broach which can be more efficient than the drill bit examples provided in FIGS. 2A-2C. In other embodiments, a shearing feature on solid core can include any other type of cutting, shearing, or manufacturing tool known in the art, to provide a desired shear and/or frictional response between the solid core and material positioned between the multi-segment core and a solid portion of the part.

Angle θ represents an angle of taper of shearing feature 22D relative to major axis Aₘ of solid core 12D. Angle θ, extending between plane 30D and major axis Aₘ, can range from 0° to less than 90°. In further embodiments, the taper angle θ can vary along a length of solid core 12D, or solid core 12D can be curvably tapered, as desired for particular embodiments.

FIG. 2E is a side view of solid core 12E, shown in isolation. Solid core 12E includes attachment feature 20E and shearing feature 22E. Shearing feature 22E includes ridge 26E. Shearing feature 22E includes a tapered shape that narrows away from attachment feature 20E. Each of attachment feature 20E and shearing feature 22E are all integrally formed as a single article during the additive manufacturing build process.

Angle θ represents an angle of taper of shearing feature 22E relative to major axis Aₘ of solid core 12E. Angle θ, extending between plane 30E and major axis Aₘ, can range from 0° to less than 90°. In further embodiments, the taper angle θ can vary along a length of solid core 12E, or solid core 12E can be curvably tapered, as desired for particular embodiments.

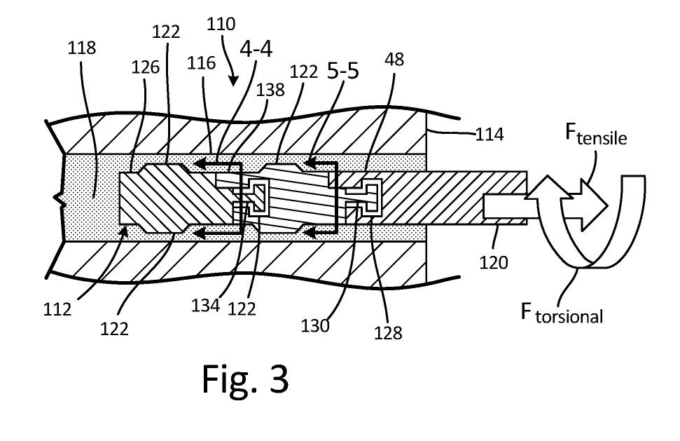

FIG. 3 is a sectional view of an embodiment of additively manufactured part 110 with multi-segment core 112. Additively manufactured part 110 includes multi-segment core 112, solid portion 114, internal passage 116, and material 118. Multi-segment core 112 includes attachment feature 120, shearing features 122, first core segment 124, and second core segment 126. The location of the section from which FIG. 3 is viewed is located slightly off-center from a center of multi-segment core 112.

Attachment feature 120 includes first female interlocking feature 128 which receives and connects with first male interlocking feature 130 of first core segment 124. First core segment 124 includes second female interlocking feature 132 which receives and connects with second male interlocking feature 134. As torsional force Fₜₒᵣₛᵢₒₙₐₗ is applied to attachment feature 120, attachment feature 120 breaks from material 118 allowing attachment feature 120 to rotate. As attachment feature 120 is rotated, first female interlocking feature 128 of attachment feature 120 engages with first male interlocking feature 130 of first core segment 124. As force Fₜₒᵣₛᵢₒₙₐₗ is further applied to attachment feature 120, first core segment 124 also breaks from material 118 due to torsional force Fₜₒᵣₛᵢₒₙₐₗ being transferred to first core segment 124 from attachment feature 120. As first core segment 124 is rotated with attachment feature 120, shearing feature 122 on first core segment 124 engages with material 118 and shears material 118 from internal passage 116. Shearing feature 122 on first core segment 124 actively removes material 118 from the portion of internal passage 116 occupied by first core segment 124 by shearing feature 122 coming into contact with material 118 and shearing material 118. Shearing feature 122 imparts a localized shearing or abrading action on material 118, thereby separating weak inter-particle bonds in material 118, which causes material 118 to be shorn or scraped away from internal passage 116.

As first core segment 124 is rotated with attachment feature 120, second female interlocking feature 132 of first core segment 124 engages with second male interlocking feature 134 of second core segment 126. As force Fₜₒᵣₛᵢₒₙₐₗ is further applied to attachment feature 120, second core segment 126 breaks from material 118 due to torsional force Fₜₒᵣₛᵢₒₙₐₗ being transferred to second core segment 126 through first core segment 124 from attachment feature 120. As second core segment 126 is rotated with first core segment 124, shearing feature 122 on second core segment 126 engages with material 118 and shears material 118 from internal passage 116.

Multi-segment core 112 provides the benefit of a staged shear and frictional response between multi-segment core 112 and material 118. As torsional force Fₜₒᵣₛᵢₒₙₐₗ is applied to attachment feature 120, there is typically only one core segment at a time that is shearing material 118. For example, as torsional force Fₜₒᵣₛᵢₒₙₐₗ is applied to attachment feature 120, attachment feature 120 first breaks from material 118 before engaging with first core segment 124. As attachment feature 120 rotates, attachment feature 120 locks with first core segment 124 causing first core segment 124 to break from material 118. Because first core segment 124 is attached to material 118 only along a length of first core segment 124, an amount of torsional force Fₜₒᵣₛᵢₒₙₐₗ required to break first core segment 124 from material 118 is proportional to the length of first core segment 124. The amount of torsional force Fₜₒᵣₛᵢₒₙₐₗ required to break first core segment 124 from material 118 is less than an amount of torsional force Fₜₒᵣₛᵢₒₙₐₗ that would be required to break a core segment with a length longer than first core segment 124 because a longer core segment would have more surface area attached to material 118 thus requiring more torsional force to be applied to break the connection between material 118 and the longer core segment. After an amount of torsional force Fₜₒᵣₛᵢₒₙₐₗ sufficient to break free all of attachment feature 120, first core segment 124, and second core segment 126 from material 118, tensile force Fₜₑₙₛᵢₗₑ is applied to attachment feature 120 to remove multi-segment core 112 from additively manufactured part 110.

In the example shown, multi-segment core 112 includes attachment feature 120 and two core segments 124 and 126. However, the illustrated embodiment is shown merely by way of example and not limitation. In other embodiments, a multi-segment core can include more or less, longer or shorter, or wider or narrower core segments and/or shearing features, to provide a desired shear and/or frictional response between the multi-segment core and material positioned between the multi-segment core and a solid portion of the part. Additionally, multi-segment core 112 can include any or all of the shearing features disclosed in each of the other embodiments included in this disclosure.

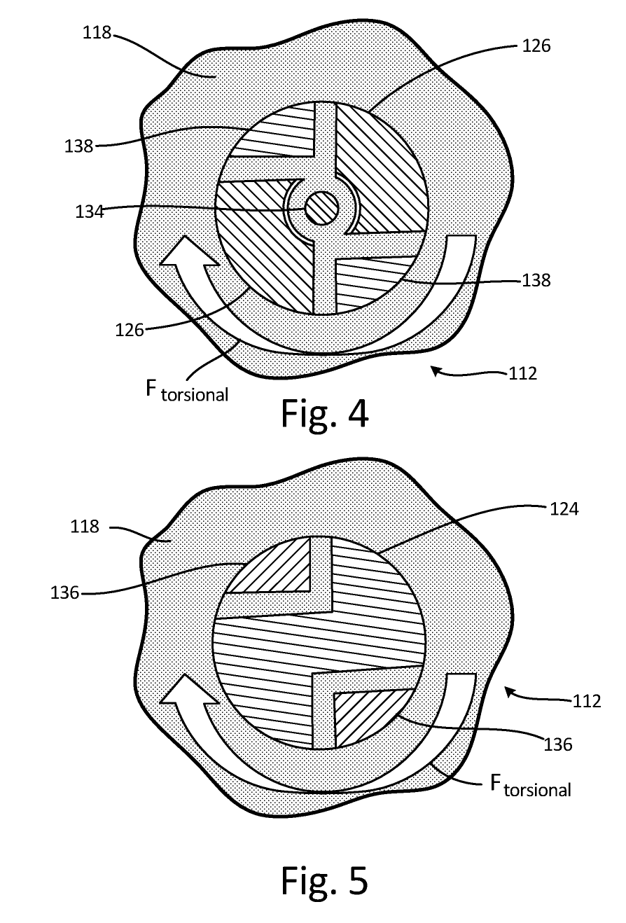

FIG. 4 is a cross-sectional view of multi-segment core 112 taken along line 4-4 of FIG. 3 and FIG. 5 is a cross-sectional view of multi-segment core 112 taken along 5-5 of FIG. 3. First core segment 124 and second core segment 126 interlock with each other such that as first core segment 124 is rotated, the spacing between first core segment 124 and second core segment 126 is reduced, first core segment comes into angular contact with second core segment 126, and torsional force Fₜₒᵣₛᵢₒₙₐₗ is transferred from first core segment 124 to second core segment 126. The interaction of first female interlocking feature 128 and first male interlocking feature 130 provides a twist-to-lock feature between first core segment 124 and second core segment 126 whereby application of relative torsional engagement between first core segment 124 and second core segment 126 causes first core segment 124 and second core segment 126 to lock with each other such that first core segment 124 and second core segment 126 can be rotated and pulled together.

Specifically, fingers 136 of attachment feature 120 enable angular contact with and transmission of torsional force Fₜₒᵣₛᵢₒₙₐₗ to first core segment 124. Fingers 138 of first core segment 124 enable angular contact with and transmission of torsional force Fₜₒᵣₛᵢₒₙₐₗ to second core segment 126. Fingers 136 and 138 include a quarter-circle cross sectional shape. First core segment 124 and second core segment 126 can have cut-outs which are shaped to receive the quarter-circle shapes of fingers 136 and 138 respectively. In other embodiments, fingers 136 and 138 can include more or less, longer or shorter, or wider or narrower shapes and/or cross-sections, to provide a desired torsional response between attachment feature 120, first core segment 124, and second core segment 126.

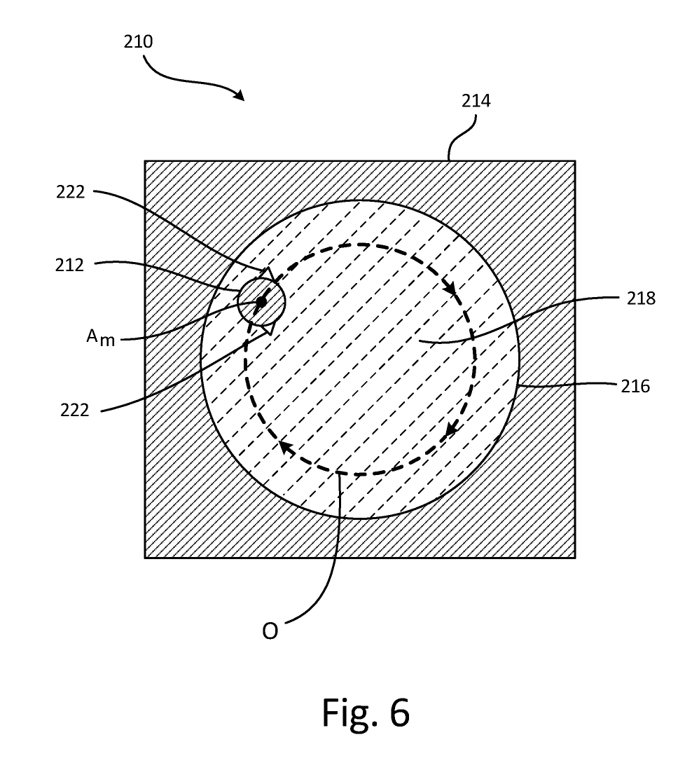

FIG. 6 is a cross-sectional view of an embodiment of additively manufactured part 210 which includes solid core 212, solid portion 214, internal passage 216, and material 218.

Solid core 212 is positioned within internal passage 216 and is located off-center relative to internal passage 216. After solid core 212 is detached from material 218, solid core 212 is rotated about major axis Aₘ of solid core 212, wherein major axis Aₘ extends through a center of solid core 212. As solid core 212 is rotated, shearing feature 122 shears material 218 from internal passage 216. Shearing feature 122 actively removes material 218 from internal passage 216 by coming into contact with material 18 and shearing material 218.

As solid core 212 is rotated about an axis Aₘ in the illustrated embodiment, solid core 212 is also moved along orbit O within internal passage 216, thereby moving solid core 212 about an epicyclic or planetary path. As solid core 212 moves along orbit O, solid core 212 shears material 218 along the path of orbit O. Solid core 212 can also be extracted from internal passage 216 (e.g., in FIG. 6, drawn into or out of the page) while being moved along orbit O. In this specific embodiment, solid core 212 incorporates a cutting behavior similar to that of a milling cutter, in that the cutting or shearing action of solid core 212 occurs as solid core moves in a radial direction (relative to solid core 212), as opposed to an axially oriented cutting direction of various other types of cutters such as drill bits.

In further embodiments, the shape of orbit O can vary to include other shapes and sizes as desired for particular embodiments. In various embodiments, orbit O can include a shape of a circle, oval, square, or triangle, for example. Additionally, the shape and size of solid core can also vary. For example, solid core 212 can have a small diameter relative to a diameter of internal passage (e.g., diameter of solid core 212 can be less than 1/10 the size of the diameter of internal passage 216). Having the diameter of solid core 212 being relatively small still allows for the removal of the same amount of material as an embodiment with a solid core with a diameter the same or similar size as orbit O, due to the cutting or shearing action of solid core 212 along orbit O, however the amount of material required to create solid core 212 is much less than would be required for the solid core with the diameter the same or similar size as orbit O.

Forming solid core 212 along with additively manufactured part 210 also provides the benefit of reducing the number of machining steps typical machining methods would require to remove material 218. For example, in order to create a hole for a milling cutter to be introduced into material 218, an axially cutting drill bit would need to first cut a hole into material 218. The axially cutting drill bit would then need to be removed, before a milling cutter bit could be introduced into the hole created by the axially cutting drill bit. Forming solid core 212 along with additively manufactured part 210 reduces the number of steps because after additively manufactured part 210 is formed, solid core 212 is already positioned within material 218 which obviates the step of axially cutting the hole into material 218.

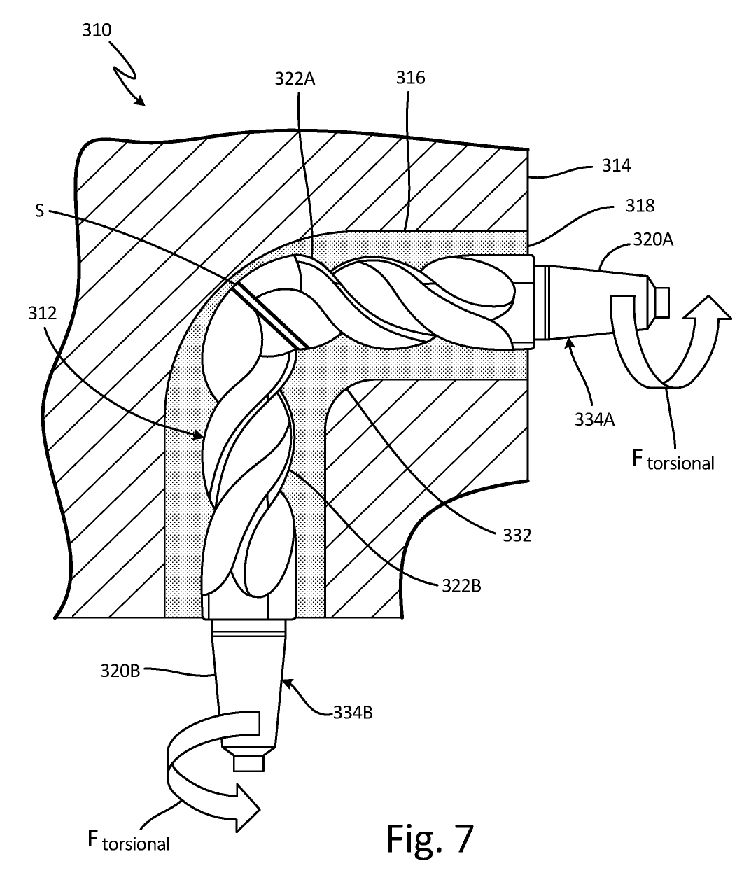

FIG. 7 is a cross-sectional view of additively manufactured part 310 which includes multi-segment core 312, solid portion 314, internal passage 316 with bend 332, and material 318. Multi-segment core 312 includes first core segment 334A and second core segment 334B. First core segment 334A includes attachment feature 320A and shearing feature 322A. Second core segment 334B includes attachment feature 320B and shearing feature 322B.

Due to the non-linear geometry of internal passage 316 with bend 332, a core configuration with more than a single linear core segment is required. If a single solid core were formed in internal passage 316 with bend 332, upon attempting removal, the single core would not pass past bend 332.

Use of first core segment 334A and second core segment 334B in additively manufactured part 310 allows for formation and removal of solid cores within an internal passage which includes a non-linear geometry. In this example, internal passage 316 includes bend 332 and essentially two major portions of passageway. As additively manufactured part 310 is formed, first core segment 334A and second core segment 334B are formed to create separation S between first core segment 334A and second core segment 334B. After additively manufactured part 310 is formed, first torsional force Fₜₒᵣₛᵢₒₙₐₗ is applied to first core segment 334A and second torsional force Fₜₒᵣₛᵢₒₙₐₗ is applied to second core segment 334B. In other examples, compressive, vibratory, or torsional forces can also be applied to either or both of first core segment 334A and second core segment 334B. These applied forces can be monotonic or cyclical.

Internal passage 316 with bend 332 is an example of an internal passage with more than just a simple linear passageway extending through additively manufactured part 310. However, the illustrated embodiment is shown merely by way of example and not limitation. In other examples, other internal passageways can include longer or shorter, or wider or narrower or bends with different shapes than internal passage 316 with bend 332.

In other embodiments, a multi-segment core can include longer or shorter, or wider or narrower core segments and/or shearing features, to provide a desired shear and/or frictional response between the multi-segment core and the material positioned between the multi-segment core and a solid portion of the part. Additionally, multi-segment core 312 can include any or all of the shearing features disclosed in each of the other embodiments included in this disclosure.

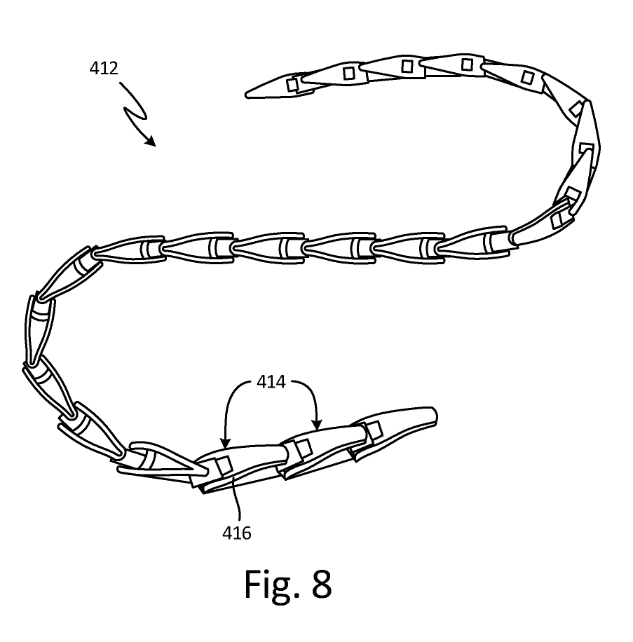

FIG. 8 is a perspective view multi-segment core 412 shown in isolation, which includes a plurality of links 414. Each link 414 includes shearing feature 416. Multi-segment core 412 can be used in any of the preceding embodiments of internal passageways including both linear internal passageways and internal passageways including complex geometries.

Each link 414 includes features allowing links 414 to pivot relative to each other. As a tensile, compressive, vibratory, and/or torsional force is applied to multi-segment core 412 and as multi-segment core 412 is maneuvered through an internal passage of an additively manufactured part during removal, links 414 to pivot relative to each other to conform to a shape of the internal passage. The ability of links 414 to conform to the shape of the internal passageway allows for the use of multi-segment core 412 in internal passageways including complex geometries and numerous bends, twists, and turns, while still being able to extract an entire length of multi-segment core 412 by applying at least one of a tensile, compressive, vibratory, or torsional force to multi-segment core 412.

Shearing feature 416 includes a sharp edge for cutting material in both an axial and radial direction. As shearing feature 416 is drawn across a material in an internal passage along either an axial or radial direction, shearing feature 416 cuts into the material inside of the internal passage. Shearing feature 416 shears away the material in the internal passage by imparting a localized shearing action on the material, thereby separating weak inter-particle bonds in the material, which causes the material to be shorn away from the internal passage.

As discussed with previous embodiments, shearing features 416 enable multi-segment core 412 to actively remove material from an internal passage as multi-segment core 412 is extracted from an additively manufactured part.

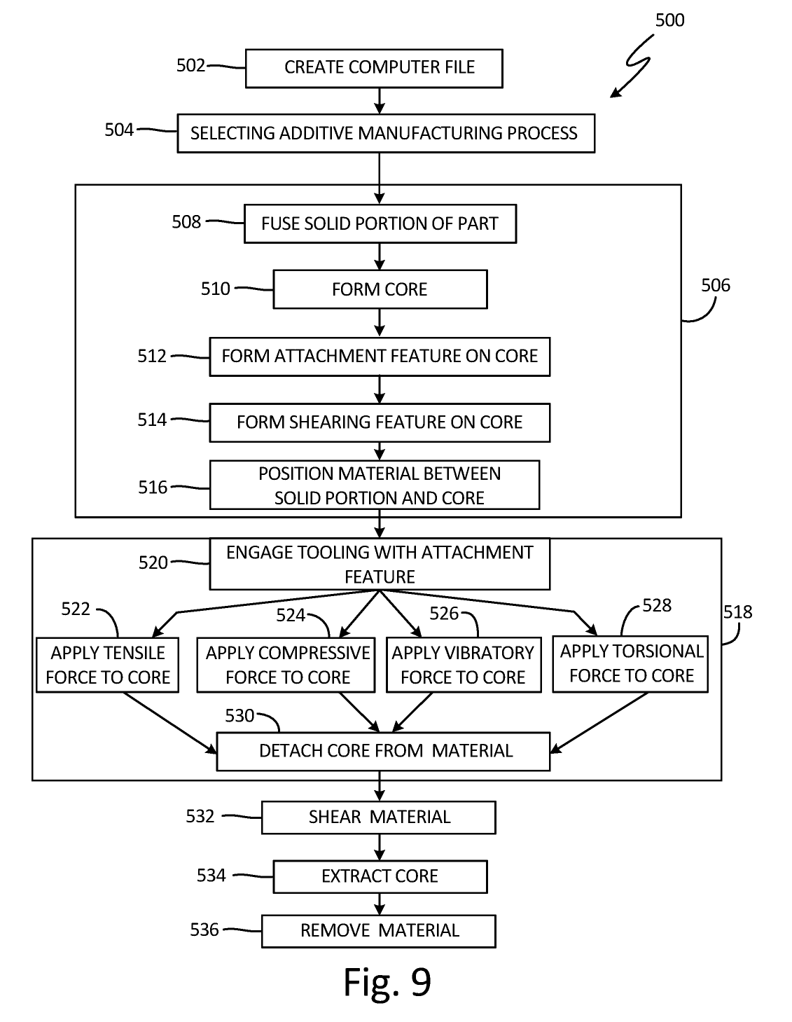

FIG. 9 is a flowchart of method 500 of additively manufacturing a part with a core, which includes a series of steps to additively manufacture a part. In this embodiment, the part is formed to include an internal passage extending through at least a portion of the part. While EBM is described, any other form of additive manufacturing or 3D printing, such as EB powder bed additive manufacturing, direct metal laser sintering (DMLS), laser powder bed fusion, electron beam powder bed fusion, laser powder deposition, electron beam wire, and selective laser sintering, as well as other powder bed methods in general, can be used.

Step 502 includes creating a computer file defining the part in layers, with the part including an internal passage and a solid portion. Step 504 includes selecting an additive manufacturing process to build the part on a layer-by-layer basis, with the additive manufacturing process being either EBM or electron beam powder bed additive manufacturing. The part can be built from powdered material such as a nickel superalloy, aluminum alloy, titanium alloy, steel alloy, cobalt alloy, or other suitable metal.

Additively building the part (collectively, Step 506) includes individual steps 508-516. Step 508 includes fusing the solid portion of the part. Step 510 includes forming a core within at least a portion of the internal passage, which includes forming at least one of a straight, threaded, angled, chain, ribbon, or helical portion that engages with a material positioned between the core and the solid portion. The material positioned between the core and the solid portion is semi-sintered or un-sintered. Sintering the core includes steps 512 and 514. Step 512 includes forming an attachment feature on the core. Step 514 includes forming a shearing feature on the core. Steps 512 and 514 can be performed concurrently. At this stage, method 500 can include either forming one core segment or forming at least two core segments. Method 500 can also include forming an interlocking feature on each core segment. Step 516 includes positioning the material between the solid portion and the core. Step 516 can be performed concurrently with steps 512 and/or 514.

Applying work to the core (collectively, Step 518), includes individual steps 520-530. Step 520 includes engaging tooling with the attachment feature on the core. After Step 520, worked can be applied to the core by one of Step 522, Step 524, Step 526, Step 528 or a combination of at least two of Steps 522-528. Step 522 includes applying tensile force to the core. Step 524 includes applying compressive force to the core. Step 526 includes applying vibratory force to the core. Vibrating the core can include at least one of pneumatically vibrating, electrically vibrating, and ultrasonically vibrating the core relative to the part. Step 528 includes applying a monotonic or repetitive impact torsional force to the core. Applying work to the core can further include engaging the interlocking features of the at least two core segments with each other to connect the at least two core segments. Step 530 includes detaching the core from the part. Step 532 includes shearing the material between the solid portion and the core with the shearing feature. Step 534 includes extracting the core from the part. Step 536 includes removing the material between the solid portion and the core from the part.

### Discussion of Possible Embodiments

The following are non-exclusive descriptions of possible embodiments of the present invention.

A method of making a part comprising a solid portion with an internal passage can include building the part using an additive manufacturing process that builds the part on a layer-by-layer basis. The solid portion of the part can be fused. A solid core can be formed within at least a portion of the internal passage. Forming the solid core can include forming an attachment feature and/or forming a shearing feature. Material that is semi-sintered or un-sintered can be positioned between the solid portion and the solid core. A force selected from the group consisting of tensile, compressive, vibratory, and/or torsional force can be applied to the solid core. The material can then be shorn with the shearing feature.

The method of the preceding paragraph can optionally include, additionally and/or alternatively, any one or more of the following features, configurations and/or additional components:

a further embodiment of the foregoing method, wherein the method can further include creating a computer file defining the part in layers;

a further embodiment of any of the foregoing methods, wherein forming the attachment feature can further include forming at least one of a hole, bore, tongue, groove, receptacle, link, insert, chuck, socket, and/or clamp on the solid core;

a further embodiment of any of the foregoing methods, the method can further comprise engaging tooling with the attachment feature on the solid core;

a further embodiment of any of the foregoing methods, wherein applying a force selected from the group consisting of a tensile, compressive, vibratory, and/or torsional force to the solid core can further include detaching the solid core from the material positioned between the solid portion and the solid core;

a further embodiment of any of the foregoing methods, wherein shearing the material positioned between the solid portion and the solid core can further include rotating the solid core about a major axis of the solid core, wherein the major axis can extend through a center of the solid core;

a further embodiment of any of the foregoing methods, wherein the method can further comprise extracting the solid core from the part;

a further embodiment of any of the foregoing methods, wherein the method can further comprise removing the material positioned between the solid portion and the solid core from the part;

a further embodiment of any of the foregoing methods, wherein removing the material positioned between the solid portion and the solid core from the part can further include applying a removal technique, wherein the removal technique can be selected from the group consisting of powder blasting and abrasive flow;

a further embodiment of any of the foregoing methods, and possibly further comprising moving an axis of the solid core in an orbit within the internal passage;

a further embodiment of any of the foregoing methods, wherein the additive manufacturing process that builds the part on a layer-by-layer basis can be selected from the group consisting of electron beam melting and electron beam powder bed additive manufacturing;

a further embodiment of any of the foregoing methods, wherein forming the solid core can further include forming a plurality of solid core segments, and/or forming a shearing feature on each of the plurality of solid core segments;

a further embodiment of any of the foregoing methods, wherein forming the plurality of solid core segments can further include forming an interlocking feature on each of the plurality of solid core segments;

a further embodiment of any of the foregoing methods, wherein applying at least one of a tensile, compressive, vibratory, or torsional force to the solid core can further include engaging the interlocking features of the plurality of solid core segments with each other to connect the plurality of solid core segments;

a further embodiment of any of the foregoing methods, wherein applying a force selected from the group consisting of a tensile, compressive, vibratory, and/or torsional force to the solid core can further include twisting the plurality of solid core segments relative to each other to engage the interlocking features on each of the plurality of solid core segments; and/or

a further embodiment of any of the foregoing methods, wherein removing the solid core can further include pivoting at least some of the plurality of solid core segments relative to each other as a force selected from the group consisting of a tensile, compressive, vibratory, and/or torsional force is applied to the solid core such that the solid core can be maneuvered through the internal passage as the solid core is removed from the part, and/or shearing the material positioned between the solid portion and the solid core with the shearing feature on each of the plurality of solid core segments as the shearing feature on each of the plurality of solid core segments is drawn through and across the material positioned between the solid portion and the solid core.

A method of making a part comprising a solid portion with an internal passage can include creating a computer file defining the part in layers. The part can be built using an additive manufacturing process that builds the part on a layer-by-layer basis. A solid core can be sintered within at least a portion of the internal passage. The solid core can include a plurality of solid core segments. A shearing feature can be sintered on each of the plurality of solid core segments. An attachment feature can be sintered on the solid core. Material that is semi-sintered or un-sintered can be positioned between the solid portion and the solid core. Tooling can be engaged with the attachment feature. A force selected from the group consisting of tensile, compressive, vibratory, and/or torsional force can be applied to the solid core. The solid core can be detached from the part. The material positioned between the solid portion and the solid core can then be shorn with the shearing feature.

The method of the preceding paragraph can optionally include, additionally and/or alternatively, any one or more of the following features, configurations and/or additional components:

a further embodiment of the foregoing method, wherein the method can further comprise extracting the solid core from the part, and/or removing the material positioned between the solid portion and the solid core from the part;

a further embodiment of any of the foregoing methods, wherein forming the solid core can further include forming an interlocking feature on each of the plurality of solid core segments;

a further embodiment of any of the foregoing methods, wherein applying a force selected from the group consisting of a tensile, compressive, vibratory, and/or torsional force to the solid core can further include engaging the interlocking features of the plurality of solid core segments with each other to connect the plurality of solid core segments, and/or twisting the plurality of solid core segments relative to each other to engage the interlocking features on each of the plurality of solid core segments.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

Any relative terms or terms of degree used herein, such as “substantially”, “essentially”, “generally”, “approximately” and the like, should be interpreted in accordance with and subject to any applicable definitions or limits expressly stated herein. In all instances, any relative terms or terms of degree used herein should be interpreted to broadly encompass any relevant disclosed embodiments as well as such ranges or variations as would be understood by a person of ordinary skill in the art in view of the entirety of the present disclosure, such as to encompass ordinary manufacturing tolerance variations, incidental alignment variations, transient alignment or shape variations induced by thermal, torsional, tensile, compressive, or vibrational operational conditions, and the like. Moreover, any relative terms or terms of degree used herein should be interpreted to encompass a range that expressly includes the designated quality, characteristic, parameter or value, without variation, as if no qualifying relative term or term of degree were utilized in the given disclosure or recitation.

1. A method of making a part comprising a solid portion with an internal passage, the method comprising:
(a) building the part using an additive manufacturing process that builds the part on a layer-by-layer basis, wherein building the part comprises:
i. fusing the solid portion of the part;
ii. forming a solid core within at least a portion of the internal passage, wherein forming the solid core comprises:
forming an attachment feature; and
forming a shearing feature;
iii. positioning a material between the solid portion and the solid core, wherein the material is semi-sintered or un-sintered;
(b) applying a force selected from the group consisting of a tensile, compressive, vibratory, and torsional force to the solid core at the attachment feature; and
(c) shearing the material positioned between the solid portion and the solid core with the shearing feature.

2. The method of claim 1, further comprising creating a computer file defining the part in layers.

3. The method of claim 1, wherein forming the attachment feature further comprises:
forming at least one of a hole, bore, tongue, groove, receptacle, link, insert, chuck, socket, and clamp on the solid core.

4. The method of claim 1, and further comprising:
engaging tooling with the attachment feature of the solid core.

5. The method of claim 1, wherein applying a force selected from the group consisting of a tensile, compressive, vibratory, and torsional force to the solid core further comprises:
detaching the solid core from the material positioned between the solid portion and the solid core.

6. The method of claim 1, wherein shearing the material positioned between the solid portion and the solid core further comprises:
rotating the solid core about a major axis of the solid core, wherein the major axis extends through a center of the solid core.

7. The method of claim 1, and further comprising:
extracting the solid core from the part.

8. The method of claim 1, and further comprising:
removing the material positioned between the solid portion and the solid core from the part.

9. The method of claim 8, wherein removing the material positioned between the solid portion and the solid core from the part further comprises:
applying a removal technique, wherein the removal technique is selected from the group consisting of powder blasting and abrasive flow.

10. The method of claim 1, and further comprising:
moving an axis of the solid core in an orbit within the internal passage.

11. The method of claim 1, wherein the additive manufacturing process that builds the part on a layer-by-layer basis is selected from the group consisting of electron beam melting and electron beam powder bed additive manufacturing.

12. The method of claim 1, wherein forming the solid core further comprises:
forming a plurality of solid core segments; and
forming a shearing feature on each of the plurality of solid core segments.

13. The method of claim 12, wherein forming the plurality of solid core segments further comprises:
forming an interlocking feature on each of the plurality of solid core segments.

14. The method of claim 13, wherein applying a force selected from the group consisting of a tensile, compressive, vibratory, and torsional force to the solid core further comprises:
engaging the interlocking features of the plurality of solid core segments with each other to connect the plurality of solid core segments.

15. The method of claim 14, wherein applying a force selected from the group consisting of a tensile, compressive, vibratory, and torsional force to the solid core further comprises:
twisting the plurality of solid core segments relative to each other to engage the interlocking features of the plurality of solid core segments.

16. The method of claim 12, wherein removing the solid core further comprises:
pivoting at least some of the plurality of solid core segments relative to each other as a force selected from the group consisting of a tensile, compressive, vibratory, and torsional force is applied to the solid core such that the solid core is maneuvered through the internal passage as the solid core is removed from the part; and
shearing the material positioned between the solid portion and the solid core with the shearing feature on each of the plurality of solid core segments as the shearing feature on each of the plurality of solid core segments is drawn through and across the material positioned between the solid portion and the solid core.

17. A method of making a part, the method comprising:
(a) creating a computer file defining the part in layers, the part comprising a solid portion with an internal passage;
(b) building the part using an additive manufacturing process that builds the part on a layer-by-layer basis, wherein building the part comprises:
i. forming a solid core within at least a portion of the internal passage, wherein the solid core includes a plurality of solid core segments;
ii. forming a shearing feature on each of the plurality of solid core segments;
iii. forming an attachment feature on the solid core;
iv. positioning a material between the solid portion and the solid core, wherein the material is semi-sintered or un-sintered;
(e) engaging tooling with the attachment feature;
(f) applying a force selected from the group consisting of a tensile, compressive, vibratory, and torsional force to the solid core;
(g) detaching the solid core from the part; and
(h) shearing the material positioned between the solid portion and the solid core with the shearing feature.

18. The method of claim 17, and further comprising:
extracting the solid core from the part; and
removing the material positioned between the solid portion and the solid core from the part.

19. The method of claim 17, wherein forming the solid core further comprises:
forming an interlocking feature on each of the plurality of solid core segments.

20. The method of claim 19, wherein applying a force selected from the group consisting of a tensile, compressive, vibratory, and torsional force to the solid core further comprises:
engaging the interlocking features of the plurality of solid core segments with each other to connect the plurality of solid core segments; and
twisting the plurality of solid core segments relative to each other to engage the interlocking features of the plurality of solid core segments.
